(19) United States
(12) Patent Application Publication
(10) Pub. No.: US 2004/0006601 A1
(43) Pub. Date: Jan. 8, 2004

(54) Method and system for optimized persistent messaging

(76) Inventors: David B. Bernstein, San Francisco, CA (US); Jerry Z. Wang, San Jose, CA (US); Jian Wang, Saratoga, CA (US); David R. Coelho, Los Altos Hills, CA (US)

Correspondence Address: Pennie & Edmonds, LLP, 3300 Hillview Avenue, Palo Alto, CA, 94304, US

(21) Appl. No.: 10/187,537

(22) Filed: Jul. 1, 2002

(51) Int. Cl. G06F 15/16

(52) U.S. Cl. 709/207

(57) ABSTRACT

An optimized persistent messaging method and system repeatedly attempts delivery of a message by alternate delivery services that are capable of delivering a message if delivery by an initial delivery service fails, until either delivery is successful or else attempted delivery by all the delivery services has failed. The optimized persistent messaging method and system also prioritizes delivery services that are capable of delivering a message according to prioritization criteria from a variety of possible sources. The optimized persistent messaging method and system repeatedly attempts delivery beginning with the highest ranked delivery service and descending down a prioritized list of delivery services, until either delivery is successful or else attempted delivery by all the delivery services has failed.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

The present invention relates generally to delivering computer network messages to wireless devices. More particularly, this invention relates to a method and system for delivering messages reliably and selecting the optimal means for delivery of messages using a set of predefined criteria.

### BACKGROUND OF THE INVENTION

Multiple delivery services may exist for delivering a computer network message, such as an e-mail message or a web page, to a wireless device, such as a cellular telephone or a pager. Typically, the available delivery services will differ in their delivery capabilities, cost and reliability. In addition, a service outage for a particular delivery service may result in a failure to deliver a message if that particular delivery service was selected. It would therefore be desirable to provide a method and system for optimizing the selection of a delivery service and automatically selecting an alternate delivery service if delivery by an initial delivery service fails.

### SUMMARY OF THE INVENTION

In one embodiment the present invention is a persistent messaging method. A message for delivery to a specified destination is received, and a set of delivery services capable of delivering the message to the specified destination is determined from a predefined universe of message delivery services. Delivery of the message is then repeatedly attempted by selecting a first delivery service from the set of delivery services, attempting delivery by the first delivery service, and if delivery is not successful, repeating the attempted delivery by the first delivery service until either delivery is successful or else a predefined message delivery failure condition occurs. If delivery by the first delivery service fails, delivery by each of the other delivery services in the set of delivery services is attempted until delivery is successful or else delivery by all the delivery services in the set of delivery services has failed.

In another embodiment, the present invention is an optimized messaging method. A message for delivery to a specified destination is received, and a first set of delivery services capable of delivering the message to the specified destination is determined from a predefined universe of message delivery services. A second, prioritized set of delivery services is generated in which the delivery services in a subset (which may be the entire set) of the first set of delivery services are ordered in accordance with a set of prioritization criteria and stored. Delivery of the message is then attempted by the highest priority delivery service from the second, prioritized set of delivery services.

In yet another embodiment, the present invention is an optimized persistent messaging method. A message for delivery to a specified destination is received, and a first set of delivery services capable of delivering the message to the specified destination is determined from a predefined universe of message delivery services. A second, prioritized set of delivery services is generated in which the delivery services in a subset (which may be the entire set) of the first set of the delivery services are ordered (sometimes called ranked) in accordance with a set of prioritization criteria and stored. Delivery of the message is then attempted by selecting the highest ranked delivery service from the second, prioritized set of delivery services, attempting delivery by the highest ranked delivery service, and if delivery is not successful, repeating the attempted delivery by the highest ranked delivery service until either delivery is successful or else a predefined message delivery failure condition occurs. If delivery by the highest ranked delivery service fails, delivery by each of the other delivery services in the second, prioritized set of delivery services is attempted in descending order until delivery is successful or else delivery by all the delivery services in the second, prioritized set of delivery services has failed.

In some embodiments, the message must be converted to a format compatible with a selected delivery service before delivery is attempted. The specified destination may be a wireless device, and the set of delivery services capable of delivering the message may include wireless message delivery services. The conversion of the message to a compatible format may involve specifying a wireless message transport protocol and a wireless message transport conduit. As used herein, a wireless message transport protocol refers to the format required for delivery of the message, and a wireless message transport conduit refers to the medium over which the message is to be delivered. The set of prioritization criteria for delivery of the message may be specified by a customer service level agreement or specified within the message. The set of delivery services may include delivery services that are capable of delivering the message to the specified destination indirectly via another delivery service. The present invention may include monitoring the delivery services to accumulate performance statistics concerning their message delivery performance and utilizing the accumulated performance statistics to determine which delivery services meet predefined minimum performance requirements or best meet the set of prioritization criteria that are applicable to messages.

In some embodiments, the present invention is implemented as a method. In other embodiments, the present invention may be implemented as a computer program product or as a message system.

### BRIEF DESCRIPTION OF THE DRAWINGS

For a better understanding of the invention, reference should be made to the following detailed description taken in conjunction with the accompanying drawings, in which:

FIG. 1 is a block diagram of a message delivery system in accordance with an embodiment of the present invention.

FIG. 2 is a block diagram of an optimized persistent messaging system in accordance with an embodiment of the present invention.

FIG. 3 is a diagram of a carrier database table for an optimized persistent messaging system in accordance with an embodiment of the present invention.

FIG. 4 is a diagram of a roaming database table for an optimized persistent messaging system in accordance with an embodiment of the present invention.

FIG. 5 is a diagram of multiple message carriers showing connectivity between the message carriers.

FIG. 6 is a diagram of a message carrier showing multiple delivery services provided by the message carrier.

FIG. 7 is a diagram of a service profile database table for an optimized persistent messaging system in accordance with an embodiment of the present invention.

FIG. 8 is a diagram of a customer profile database table for an optimized persistent messaging system in accordance with an embodiment of the present invention.

FIG. 9 is a diagram showing inputs to an optimized persistent messaging system in accordance with an embodiment of the present invention.

FIG. 10 is a flowchart of a method for optimized persistent messaging in accordance with an embodiment of the present invention.

FIG. 11 is a block diagram of a method for optimized persistent messaging in accordance with an embodiment of the present invention.

FIG. 12 is a block diagram of a method for optimized persistent messaging showing monitoring of message delivery in accordance with an embodiment of the present invention.

FIG. 13 is a diagram of an example of delivery services for four carriers.

FIG. 14 is a block diagram of a message delivery system in which messages are transferred through two firewalls using proxies in accordance with an embodiment of the present invention.

FIG. 15 is a block diagram of a message delivery system in which messages are transferred through either an e-mail or XML gateway in accordance with an embodiment of the present invention.

### DESCRIPTION OF THE PREFERRED EMBODIMENTS

### Overview of Optimized Persistent Messaging System

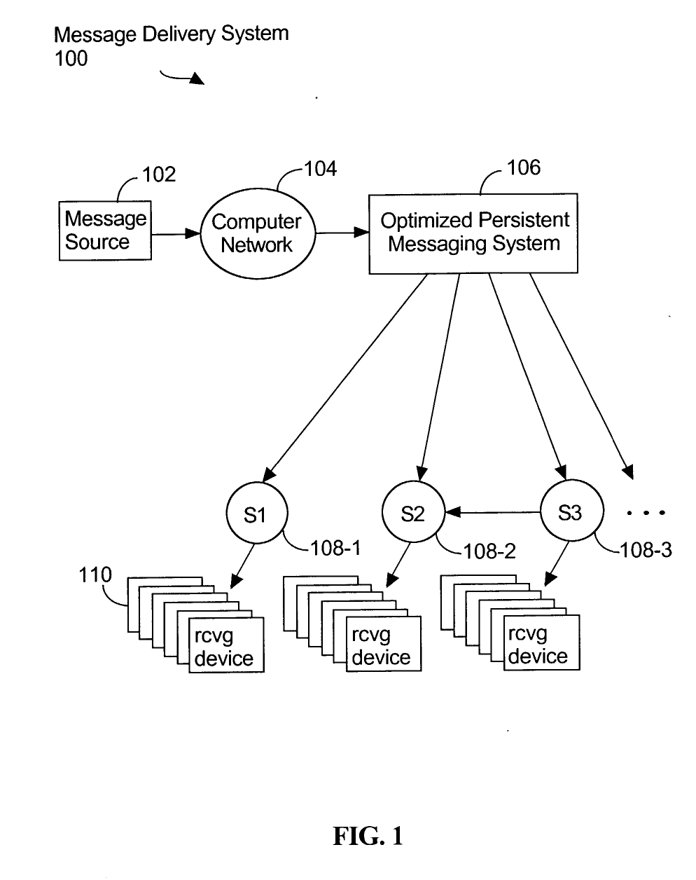

Referring to FIG. 1, there is shown a message delivery system in accordance with an embodiment of the present invention. A message source 102 transmits a message to a computer network 104. The message source 102 may be an e-mail, a web page, database content, a wireless receiver, monitoring system data, or a similar source of data for the computer network 104. The network message is routed to an optimized persistent messaging (OPM) system 106, where a prioritized list of delivery services 108-1, 108-2, or 108-3 for the network message is generated. The OPM system 106 selects the highest service from the prioritized list and converts the network message to a transport message suitable for delivery by the highest priority service. The OPM system 106 then directs the transport message to the selected carrier which then delivers the transport message to a receiving device 110. In some instances, one service may transfer a transport message to another service for delivery to the receiving device. As shown in FIG. 1, for example, the OPM system 106 may send a transport message either directly to (the carrier for) service S2 108-2 or indirectly to service S2 108-2 via service S3 108-3. (When a message is “sent to a service” it is actually sent to the carrier implementing that service.) In a preferred embodiment, at least a subset (i.e., at least some) of the receiving devices are wireless receivers, such as cellular telephones that are identified by a personal identification number (PIN).

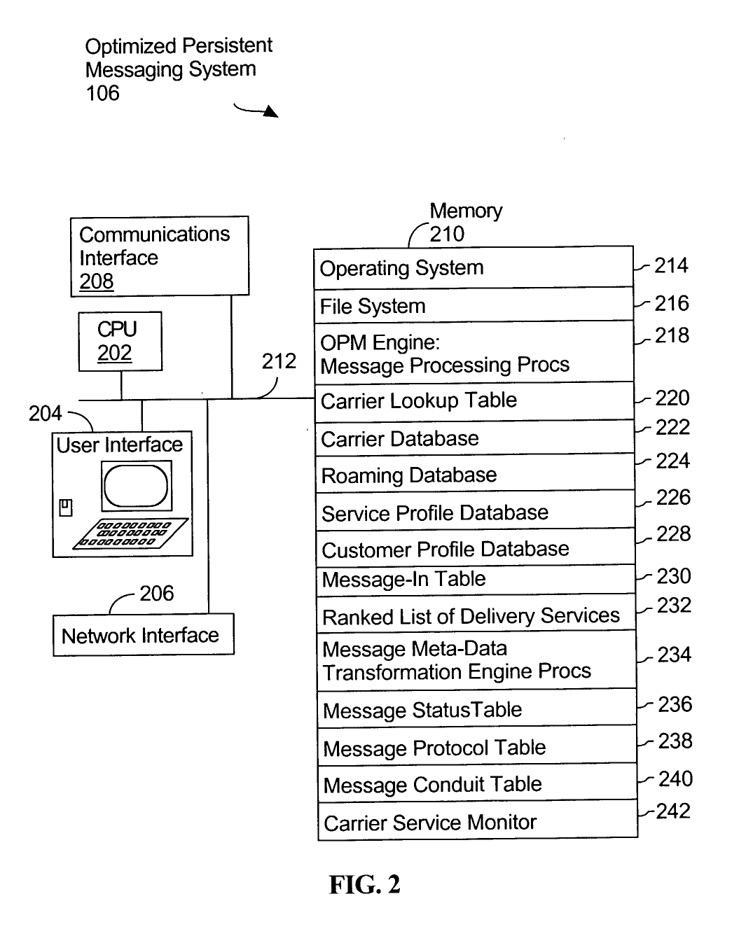

FIG. 2 illustrates an OPM system 106 implemented with a general purpose computer that includes one or more central processing units 202, a user interface 204, one or more communication interfaces 206 (e.g., a network interface to a local and/or wide area network) and 208 (e.g., a telephone network interface), and memory 210, all of which are linked by one or more system buses 212. Memory 210 may include high speed random access memory and may also include nonvolatile mass storage, such as one or more magnetic disk storage devices. Memory 210 may include mass storage that is remotely located from the central processing unit(s) 202.

The memory 210 stores an operating system 214 and a file system 216, as well as data and executable programs used to implement the present invention. In particular, the memory 210 stores executable programs for an OPM engine 218, a message meta-data transformation engine 234 and a carrier service monitor 242. The OPM engine 218 generates a ranked list of qualified delivery services 232 based on multiple criteria, and attempts delivery of the message using the delivery services listed in the ranked list in descending order until the message is delivered or else all the delivery services have failed to deliver the message. The message meta-data transformation engine 234 converts the message into a transport message suitable for delivery by a selected delivery service by specifying a message transport protocol and a message transport conduit for the selected delivery service. An embodiment of a message meta-data transformation engine 234 is described in U.S. Pat. No. 6,347,340, which is incorporated by reference herein. The carrier service monitor 242 monitors delivery of messages and stores delivery statistics in database tables in the memory 210.

### Database Tables in the Optimized Persistent Messaging System

The memory 210 also stores a number of tables, including a carrier lookup table 220, carrier database 222, a roaming database 224, a service profile database 226, a customer profile database 228, a message-in table 230, a ranked list of qualified delivery services 232, a message status table 236, a message protocol table 238, and a message conduit table 240. The carrier lookup table 220 identifies the primary carrier for a receiving device. The receiving device is identified by a personal identification number (PIN) provided in a message, and the PIN is used to perform a lookup in the carrier lookup table 236. The carrier database 222, roaming database 224, service profile database 226 and customer profile database 228 may be implemented using Structured Query Language (SQL) database tables. Exemplary SQL schemas for the carrier database 222, roaming database 224, service profile database 226 and customer profile database 228 are shown in Appendix A. These tables are described below.

The message status table 236 stores the text of the network message as well as information concerning its delivery status, including its priority, whether it is queued for delivery or delivered, and the number of unsuccessful attempts at delivery. The message status table 236 is linked to the message protocol table 238 and the message conduit table 240, which specify a message protocol and message conduit for the message using the selected delivery service.

In alternate embodiments of the present invention, two or more of the above tables may be combined into larger tables. For example, the message status table 236, message protocol table 238 and message conduit table 240 may be combined into a message-out table.

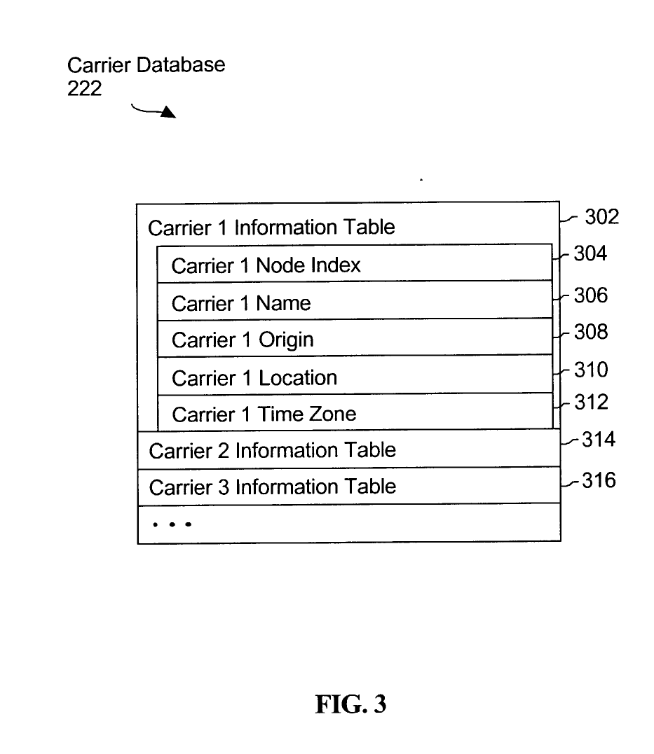

FIG. 3 illustrates a carrier database 222. A carrier is a communications network that provides at least one message delivery service. Examples of carriers include Pacific Bell, Nextel, Skytel and British Telecommunications. A carrier information table 302, 314 and 316 is provided for each carrier. Each carrier information table 302, 314 and 316 includes a carrier node index 304 that uniquely identifies the carrier. FIG. 3 also provides the following fields in the carrier information tables for each carrier: a carrier name field 306, a carrier origin field 308, a carrier location field 310 and a carrier time zone field 312. In some embodiments, fewer fields may be used, or alternatively, additional fields may be provided.

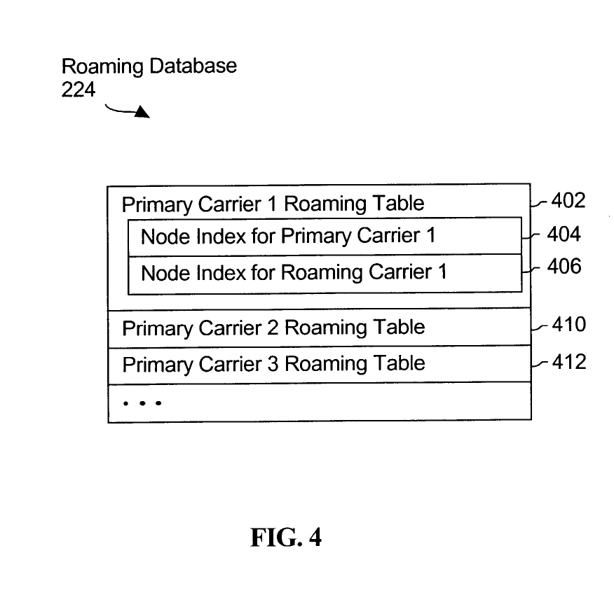

FIG. 4 illustrates a roaming database 224. A roaming carrier is a carrier that provides delivery services for a primary carrier so that a message may be delivered through both the primary carrier and the roaming carrier. A primary carrier roaming table 402, 410 and 412 is provided for each primary carrier that receives delivery services from a roaming carrier. Each primary carrier roaming table 402, 410 and 412 includes a node index 404 to identify the primary carrier and a node index 406 for a roaming carrier associated with the primary carrier. In an alternate embodiment, instead of defining a single primary carrier—roaming carrier pair in each primary carrier roaming table 402, the table 402 includes a variable number roaming carrier node indices 406 so that one table 402 can indicate multiple roaming carriers for a single primary carrier.

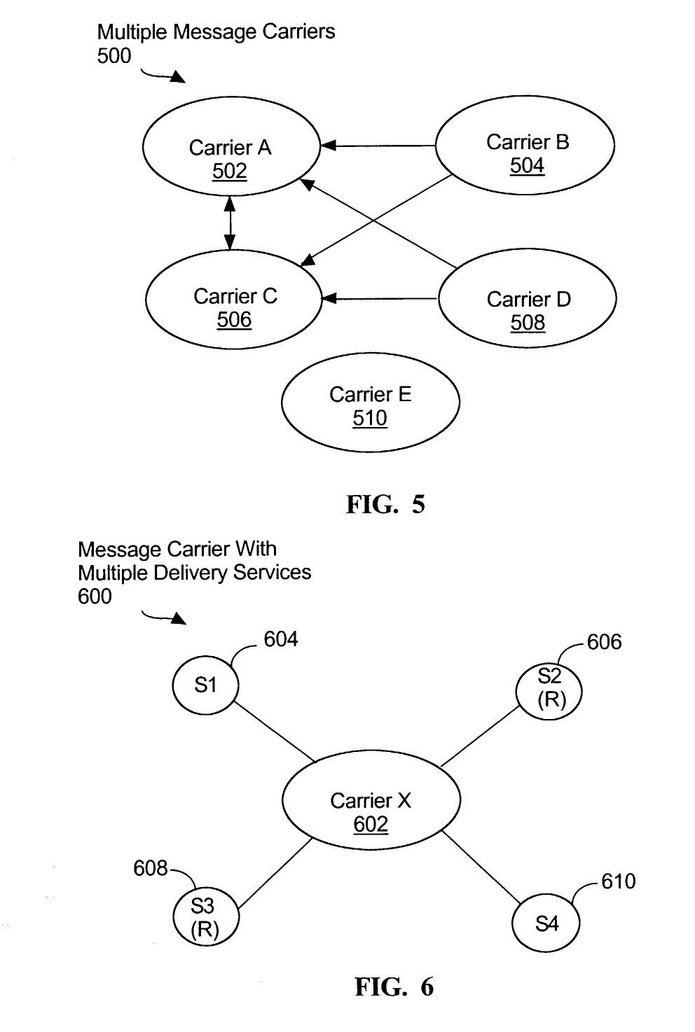

FIG. 5 illustrates multiple message carriers 500 with roaming relationships between various carriers. In FIG. 5, the roaming relationships are indicated by arrows with an arrow pointing to a carrier indicating that the carrier is provided roaming services by the carrier from which the arrow originates. In general, roaming relationships are directional and non-transitive. In the example shown in FIG. 5, Carrier A 502 and Carrier C 506 are provided roaming services by Carrier B 504 and Carrier D 508, but neither Carrier A 502 nor Carrier C 506 provides roaming services for Carrier B 504 nor Carrier D 508. In addition, Carrier A 502 provides roaming services for Carrier C 506, and Carrier C 506 provides roaming services for Carrier A 502. Finally, Carrier E 510 does not provide roaming services for any of the other carriers, and none of the other carriers provide roaming services for Carrier E 510.

FIG. 6 illustrates a message carrier with multiple delivery services 600. In the example shown in FIG. 6, Carrier X 602 has four delivery services S1 604, S2 606, S3 608 and S4 610 associated with it. Examples of delivery services that may be available include e-mail, one way alphanumeric paging, tone numeric paging, Internet paging, cellular short message service (SMS) and cellular telephone services. A carrier that provides roaming services for another carrier may provide roaming capabilities for only some of its delivery services. In the example shown in FIG. 6, Carrier X 602 provides roaming capabilities only for the delivery services S2 606 and S3 608 that are indicated by (R).

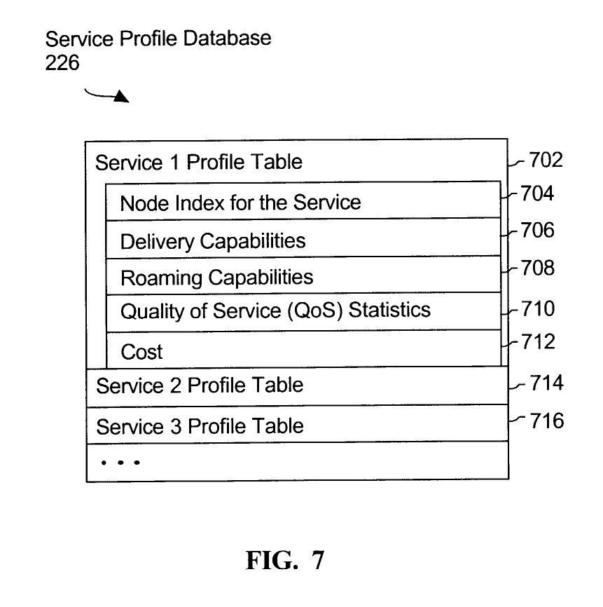

FIG. 7 illustrates a service profile database 226. A service profile table 702, 714 and 716 is provided for each service. Further, in one preferred embodiment each service, as represented by a service profile table, is specific to a particular carrier. In other embodiments, however, a service may be associated with two or more carriers. This may occur, for example, when two carriers merge and one of the carriers adopts or integrates a service (e.g., an email service) provided by the other. Alternate data structures for supporting such alternate embodiments are discussed below.

Each service profile table 702, 714 and 716 includes a service node index 704 to identify the particular service. The node index 704 preferably identifies both the carrier to which the service belongs and the particular service. Additional fields in each service profile table 702, 714 and 716 are provided for storing information indicating the delivery capabilities 706, roaming capabilities 708, quality of services (QoS) statistics 710 and the cost 712 of the particular service. The field for delivery capabilities 706 may comprise a number of fields for various categories of delivery capabilities, including the bandwidth and maximum message length for the service. Additional delivery capabilities (e.g., parameters specifying how messages longer than the maximum message length are handles, and parameters specifying the maximum number of delivery attempts and service attempts before message delivery is aborted) that may be included in the service profile table of a service are listed in the service profile database table schema in Appendix A. The field for QoS statistics will typically include information on latency (i.e., the expected time to send a message) for the service and may comprise additional fields as well.

In embodiments where a service can be supported by two or more carriers, the structure of the service profile tables 702, 714, 716 may be modified to support this functionality. For example, one or more “carrier fields” may be added to one or more of the service profile tables to store carrier identifiers that identify the carriers associated with the service. In different implementations, the carrier field(s) may either be included in all service profile tables, or only in those for services that are supported by more than one carrier. The node index 704 may be modified to either indicate only the service and not the carrier, or the carrier indicated by the node index may remain unchanged (thereby identifying one of the carriers that support the service), or a predefined special carrier ID may be used in the node index to indicate that the service is supported by two or more carriers and that the carriers are identified elsewhere in the service profile table (e.g., in one or more carrier fields). In another implementation, “duplicate” copies of a service profile table, but with different node index values, may be included in the service profile database 226 for those services supported by two or more carries. Each copy of the service profile table would have a node index that identifies a respective one of the carriers that supports the service. In yet another embodiment, a “dummy carrier” represents each group of carriers that support a shared service. The service profile table for each service supported by two or more carriers includes a node index that references the respective dummy carrier.

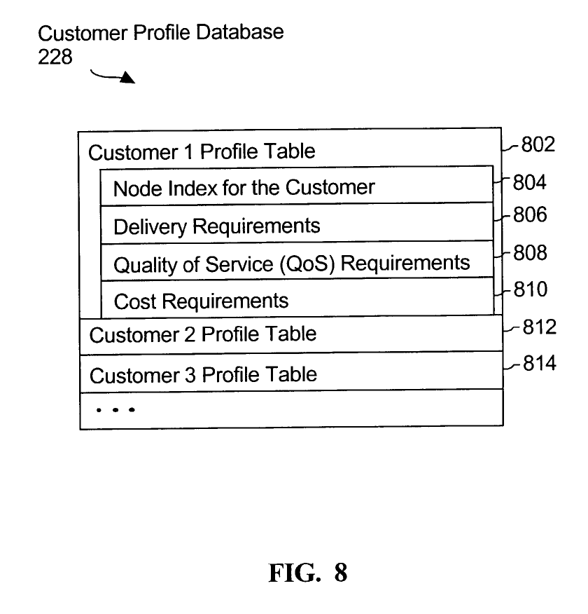

FIG. 8 illustrates a customer profile database 228. A customer profile table 802, 812 and 814 is provided for each customer. Each customer profile table 802, 812 and 814 includes a customer node index 804 to identify the customer. Additional fields in each customer profile table 802, 812 and 814 are provided for specifying the customer's delivery requirements 806, quality of service (QoS) requirements 808 and cost requirements 810. The field for delivery requirements 806 may include a number of fields for various categories of delivery requirements, such as whether an opportunity for the recipient to reply to the message must be provided and whether the message includes characters (such as Chinese characters) other than ASCII characters. Additional delivery requirements (e.g., a latency limit) that may optionally be specified in the delivery requirements field 806 are listed in the customer profile database table schema in Appendix A. The field for QoS requirements may include the customer's upper limit for latency as well as other QoS requirements that a customer may specify.

### Description of Inputs to the Optimized Persistent Messaging System

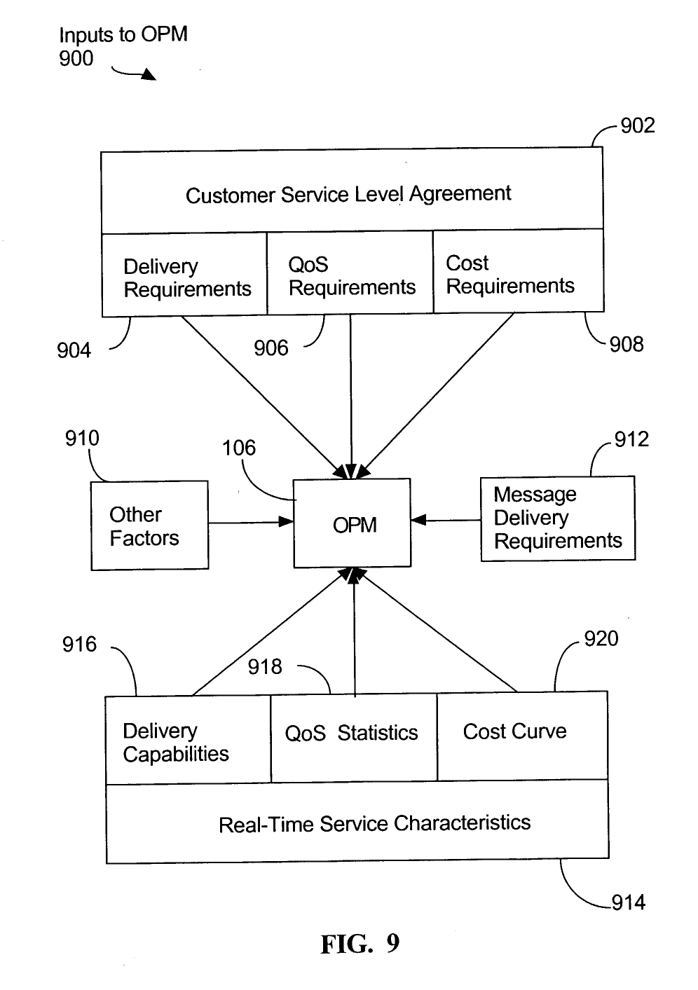

FIG. 9 illustrates inputs to the optimized persistent messaging (OPM) system 900 that the OPM system 106 may use to generate the ranked list of qualified services 232 (FIG. 2). One set of inputs originates in customer service level agreements 902 (SLA's) that may specify delivery requirements 904, quality of service (QoS) requirements 906 and cost requirements 908 for each customer. In addition, a message itself may specify message delivery requirements 912 applicable to the particular message. Other factors 910, such as an overall system profit goal or business relationships with carriers, may also be included as inputs to the OPM system 106. The OPM system 106 matches the preceding inputs to the real-time service characteristics 914 of the delivery services to produce the ranked list of qualified services. The real-time service characteristics 914 include the delivery capabilities 916, quality of service (QoS) statistics 918 and a cost curve 920 for each of the delivery services (i.e., from the information in the service profile database 226, FIG. 7). In general, the cost for delivery services is a function of the message volume over an accounting period. Accordingly, an estimate of the expected message volume for the accounting period may be needed to calculate the cost for delivery of a particular message from the cost curve 920.

More specifically, the OPM system 106 compares the delivery requirements of a message with the capabilities of each of the available delivery services that are applicable to the message. The delivery service that best meets the message delivery requirements is ranked highest in the list, the delivery service that next best meets the message delivery requirements is ranked second highest in the list, and so on. In one embodiment, the OPM system 106 applies predefined criteria to determine how the delivery services that meet the minimum delivery requirements of the message should be ranked. For instance, the OPM system 106 may use a linear or nonlinear equation to compute a figure of merit for each qualifying delivery service (i.e., that meets the minimum delivery requirements of the message), and then rank the delivery services based on the figures of merit for the qualifying delivery services.

### The Optimized Persistent Messaging Method

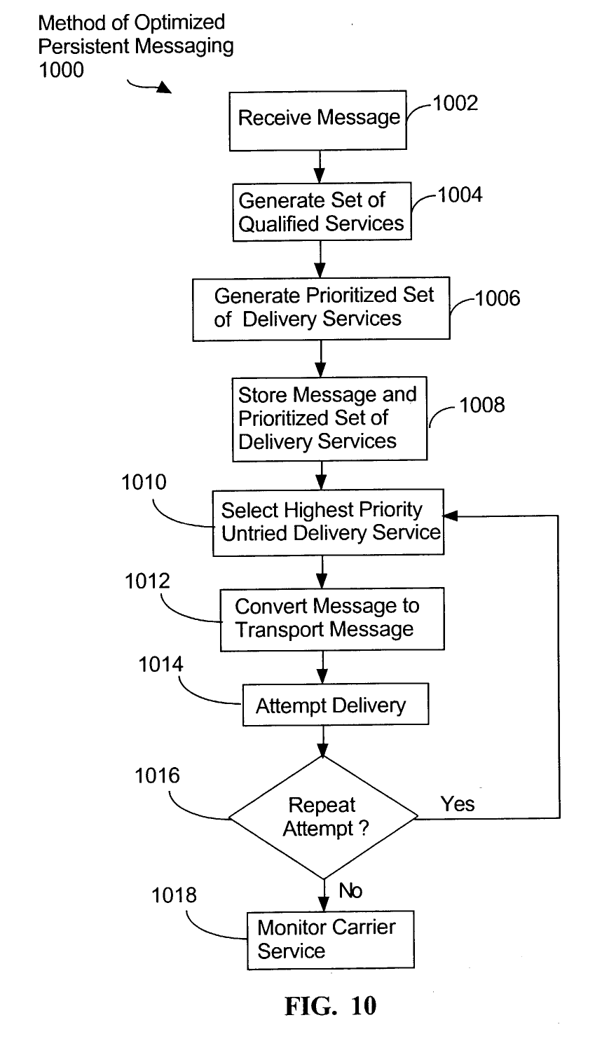

FIG. 10 is a flowchart for an optimized persistent messaging method 1000 according to an embodiment of the invention. In step 1002, a network message is received by an OPM system 106, which generates a first set of qualified services from a universe of available services in step 1004. The qualified services are those delivery services that meet the minimum delivery requirements of the message, as determined by a comparison of the message's delivery requirements with the delivery capabilities of the available delivery services. A second, prioritized set of qualified services is generated in step 1006 using a number of prioritization criteria. The prioritized set of qualified services may include all the qualified services in the first set of qualified services, or it may include fewer than all the qualified services in the first set of qualified services. Thus, the prioritized set of qualified services is a subset of the first set of qualified services, where a subset is defined as including either all of the first set of qualified services or fewer than all of the first set of qualified services. The network message and the second prioritized set of the qualified services 232 are stored in memory 210 in step 1008.

Delivery of the message is then repeatedly attempted in steps 1010 through 1014 using the prioritized set of the qualified services 232 until the delivery succeeds or another termination event occurs. Various criteria may be applied to determine whether a delivery is successful. For example, the message may be split into multiple parts with some parts being delivered at different times, and the criteria for a successful delivery may require successful delivery of all parts of the message. In addition, if a reply to a message is required, the criteria for a successful delivery may require receipt of the reply. An example of another termination event besides successful delivery of a message may be that delivery has been attempted and failed a predefined number of times.

In step 1010, the highest priority delivery service from the second, prioritized set of the qualified services that has not yet been tried is selected by an OPM engine 218. Next in step 1012, the network message is converted to a transport message (e.g., by a message meta-data transformation engine 234, or by any other appropriate message conversion mechanism), which specifies a message protocol and message conduit for delivery by the selected delivery service. Delivery of the transport message using the selected delivery service is attempted in step 1014, and if the initial delivery fails, the attempted delivery may be repeated a predetermined number of times.

If delivery of the transport message by the selected delivery service succeeds, possibly after a number of repeated attempts, the successful delivery is reported to a monitor of delivery performance, and the optimized persistent messaging method 1000 is completed. If delivery by the selected delivery service fails (as determined in step 1016), possibly after a number of repeated attempts, step 1010 is repeated by selecting the next delivery service from the second prioritized set of the qualified services 232 that has not yet been tried. Steps 1012 and 1014 are then performed using the selected delivery service. These steps (1010, 1012, 1014 and 1016) are repeated until either an attempted delivery of the message succeeds, or else all of the qualified services on the second prioritized set of the qualified services 232 have been tried unsuccessfully. After either an attempted delivery succeeds or attempts by all the qualified services have failed, the outcome is reported to a monitor of delivery performance in step 1018, and the optimized persistent messaging method 1000 is completed.

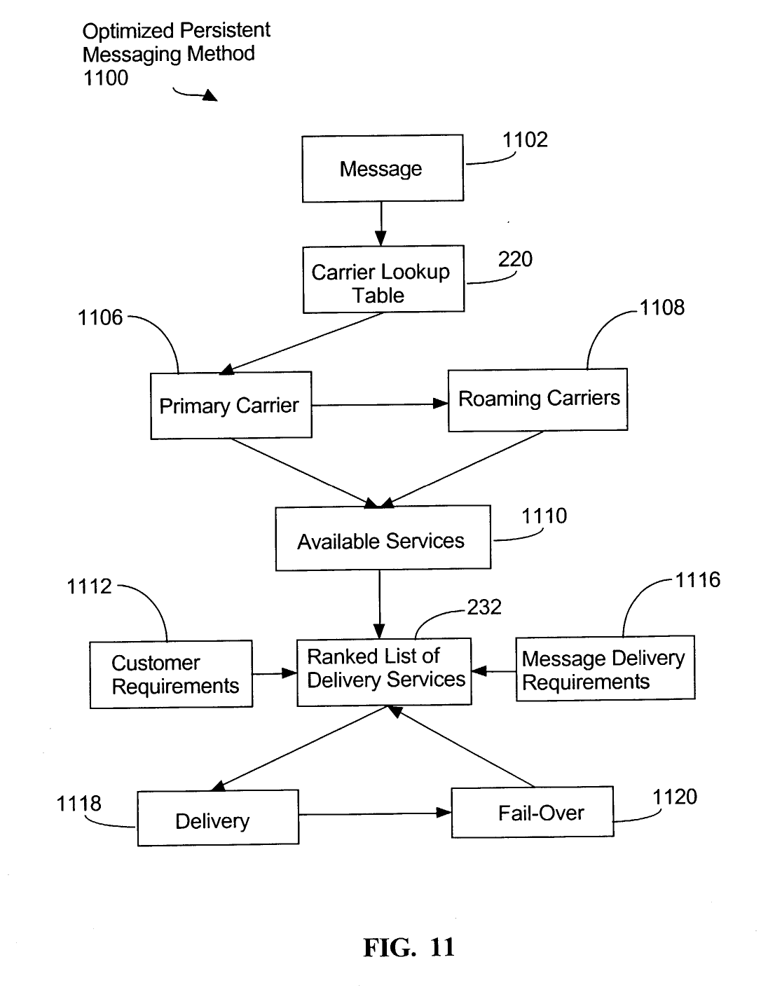

FIG. 11 illustrates an optimized persistent messaging method 1100 according to an embodiment of the invention. As shown in FIG. 11, a message 1102 is received by the OPM system 106. In addition to its textual content, the message includes a personal identification number (PIN) for the receiving device to which it is to be delivered; the message may also include special message delivery requirements 1116. The OPM system 106 performs a lookup operation in the carrier lookup table 220 to determine the primary carrier 1106 corresponding to the PIN for the receiving device.

In a preferred embodiment, the carrier lookup table 220 includes entries based on telephone number prefixes (each entry identifies a telephone number prefix and a corresponding carrier), plus a table of exceptions. The exceptions table identifies telephone numbers whose carrier is different from the carrier associated with the telephone number's prefix, and identifies the carrier for each such telephone number. Other table structures could be used in order to reduce the number of entries in the carrier lookup table 220. For instance, entries could include wildcards or variable length prefixes so that individual entries can represent a respective blocks of prefixes or a block of telephone number exceptions. An initial carrier determination is made by looking up a telephone number's prefix in the carrier lookup table 220 to obtain a carrier identifier. Further, the exceptions table (which may be considered to be a part of the carrier lookup table 220, even if it is implemented as a separate table structure) is searched for the full telephone number (or a longer prefix of the number), and if an exceptions entry is found, the carrier identified by that entry is used as the carrier for the specified telephone number.

The OPM system 106 then uses the roaming database 224 to identify the roaming carriers 1108 for the identified primary carrier 1106, and together the primary carrier and roaming carriers comprise the universe of available services 1110 for delivery of the message 1102. The OPM engine 218 generates a rank list of qualified services 232 from the universe of available services 1110 by matching the customer requirements 1112 from the customer profile database table 228 and the message delivery requirements 1116 from the message 1102 to the service capabilities in the service profile database 226. The OPM engine 218 then proceeds to attempt delivery 1118 of the message 1102 using the highest priority delivery service in the ranked list of qualified services 232. If the attempted delivery 1118 fails, the OPM engine 218 proceeds to fail-over 1120 and works its way down the ranked list of qualified services 232 until either the delivery succeeds or else all the qualified services have been tried and have failed to result in delivery.

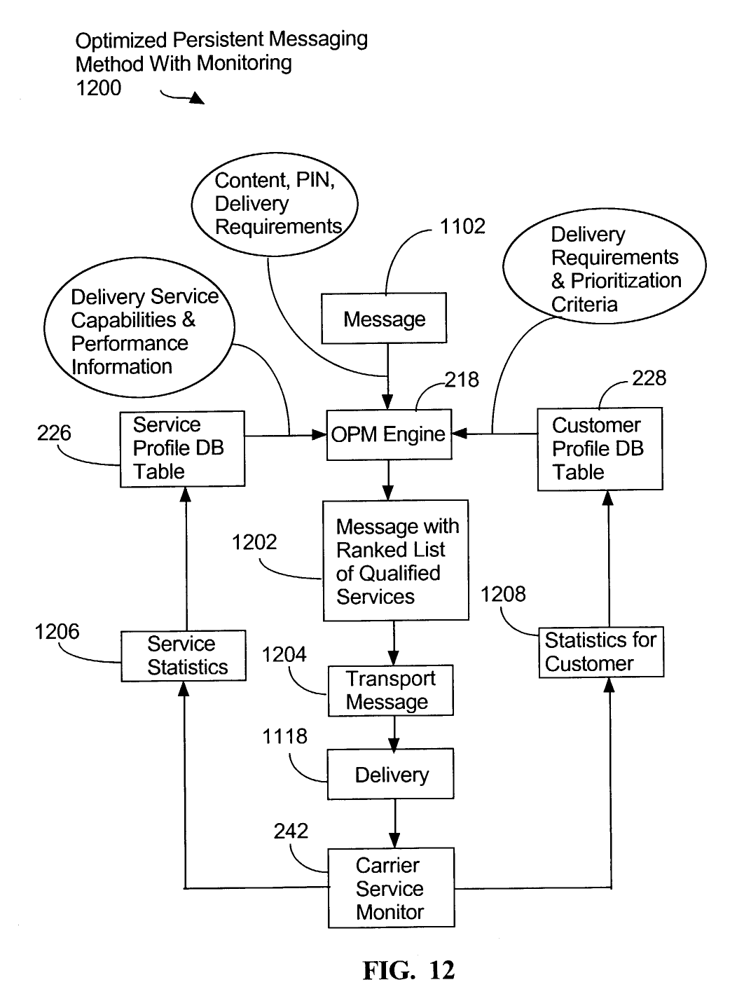

FIG. 12 illustrates an optimized persistent messaging method 1200 showing monitoring of message delivery according to an embodiment of the invention. As shown in FIG. 12, a message 1102 is received by the OPM engine 218. The message 1102 includes content and a personal identification number (PIN) for the receiving device to which it is to be delivered; the message may also include parameters or fields specifying special message delivery requirements. The customer profile database table 228 provides delivery requirements and prioritization criteria to the OPM engine 218, and the service profile database table 226 provides delivery capabilities and performance information to the OPM engine 218. The OPM engine 218 matches message delivery requirements obtained from the customer profile database table 228 and any special message delivery requirements for the message 1102 with the delivery capabilities of the available delivery services, as specified in the service profile database table 226, and outputs the message with a ranked list of qualified services 1202. The message meta-data transformation engine 234 then generates a transport message 1204, which specifies a message protocol and message conduit for delivery by the highest priority untried delivery service on the ranked list of qualified services 232. The OPM system 106 repeatedly attempts delivery 1118 of the message until the delivery is successful or all the qualified delivery services have been tried and failed. The delivery performance is monitored by the carrier service monitor 242. The carrier service monitor 242 then generates service statistics 1206 for storage in the service profile database table 226 and statistics for the customer 1208 for storage in the customer profile database table 228.

### AN EXAMPLE

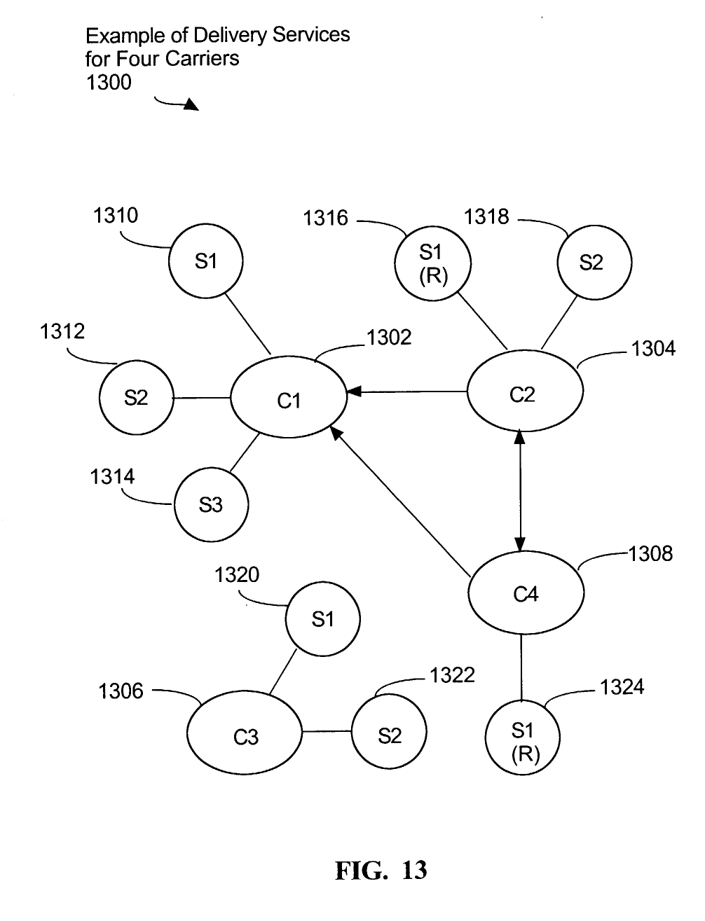

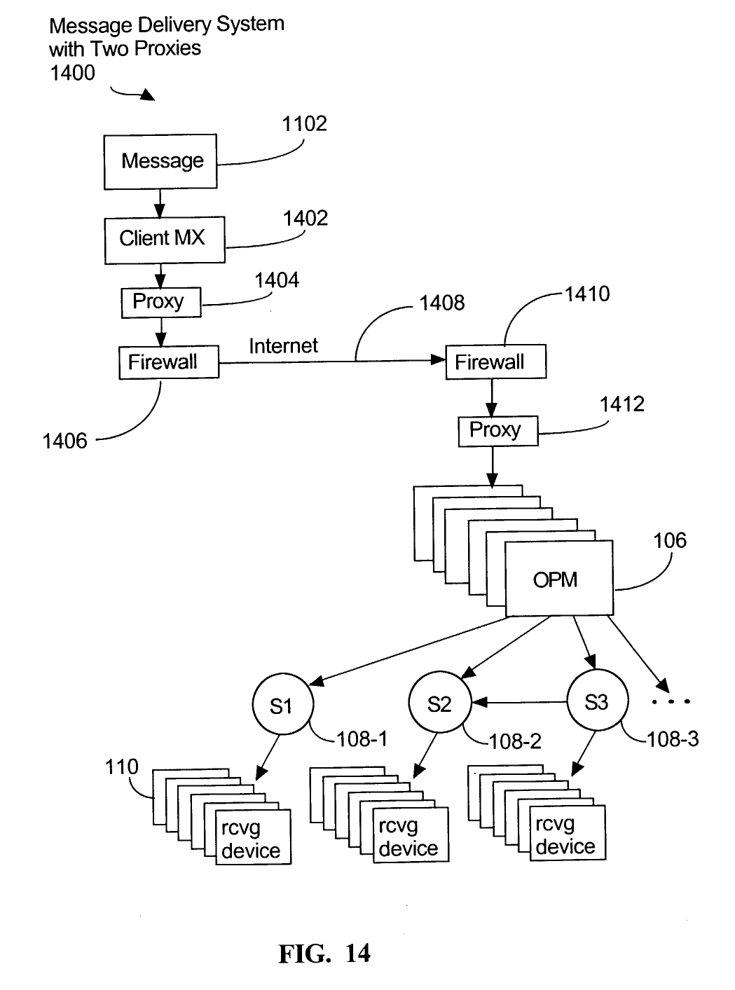

It may be helpful to a clear understanding of the present invention to work through a simplified example of delivery of a message using the delivery services for four carriers C1, C2, C3 and C4 that are illustrated in FIG. 13. A simplified example of a configuration XML file for generating some of the tables for an OPM system 106 in which four carriers are represented is found in Appendix B. The configuration XML file in Appendix B has a number of major sections entitled db server, carrier, service, recipient, agent and license. The overall format of the configuration XML in Appendix B is shown below.

<?xml version=“1.0”?>
<!DOCTYPE mobilesys SYSTEM “mobilesys.dtd”>
<mobilesys>

<!-db node -->
<node id=“opm_db class=“dbserver” name=“opm test DB”>

. . .

</node>
<!-carrier node -->
<node id=“pacbell” class=“carrier” name=“PacBell”>

. . .

</node>
. . .

</mobilesys>

The carrier section of the configuration XML file in Appendix B lists the following four carriers: Pacbell, BTCellNet, Vodafone and Nextel. The carrier section for Pacbell and BTCellNet is shown below.

<!-- +++++++++++++++++++++++ Carrier Section +++++++++++++++++ -->

<!-- the carrier nodes -->
<node id=“pacbell” class=“carrier” name=“” priority=“0”>

<carrier>

<carrier_name>pacbell</carrier_name>
<carrier_location>US</carrier_location>
<carrier_timezone>-0900</carrier_timeZone>

</carrier>

<roaming/>

</node>
<!-- the carrier nodes -->
<node id=“btcellnet” class=“carrier” name=“” priority=“0”>

<carrier>

<carrier_name>btcellnet</carrier_name>
<carrier_location>UK</carrier_location>
<carrier_timezone>O</carrier_timezone>

</carrier>

<roaming>

<roaming_roamfor>pacbell</roaming_roamfor>
<roaming_roamfor>vodafone</roaming_roamfor>

</roaming>

</node>

The carrier section above indicates that Pacbell does not provide roaming services for any of the carriers and BTCellNet provides roaming services for both Pacbell and Vodafone. The roaming relationships between the four carriers in the carrier section are illustrated by the arrows in FIG. 13 with C1 1302 representing Pacbell, C2 1304 representing BTCellNet, C3 1306 representing Nextel and C4 1308 representing Vodafone. As shown in FIG. 13, both C2 1304 (BTCellNet) and C4 1308 (Vodafone) provide roaming services for C1 1302 (Pacbell) (because the arrows points from both C2 1304 and C4 1308 to C1 1302). Similarly, C4 1308 (Vodafone) provides roaming services for C2 1304 (BTCellNet), and C2 1304 (BTCellNet) provides roaming services for C4 1308 (Vodafone). These relationships may also be represented by the following Table 1.

TABLE 1
Roaming Relationships Between Carriers

| | pachell | btcellnet | nextel | vodafone |
|---|---|---|---|---|
| pacbell | | ✓ | | ✓ |
| btcellnet | | | | ✓ |
| nextel | | | | |
| vodafone | | ✓ | | |

The services section of the configuration XML file in Appendix B has nodes for the delivery services provided by the four carriers. In addition to specifying the protocol and conduit for the delivery services, the services section provides profile information for the delivery services. The profile information includes the identification of the carrier for the delivery service, the cost of the delivery service, the bandwidth limit imposed by the carrier, statistical information about the latency of the delivery service, and delivery capabilities, such as whether the delivery service is capable of sending a 1.7-way message (i.e., a message which permits a multiple choice response). A portion of the services section of the configuration XML file in Appendix B that has information for services provided by BTCellNet appears below.

<!-- ++++++++++++++++++++++ Services Section ++++++++++++++++++++-->

<!-- PacBell service -->
. . .
<!-- BTCellnet SMTP service -->
<node id=“btcellnet:smtp” class=“service” name=“BTCellnet Email Server”

priority=“0”>

<profile>

<profile_carrier>btcellnet</profile_carrier>
<profile_cost>6</profile_cost>
<profile_latency>400</profile_latency>
<profile_bandwidth>3</profile_bandwidth>
<profile_maxDeliveryAttempts>1</profile_maxDeliveryAttempts>
<profile_splitLimit>1000</profile_splitLimit>
<profile_maxLength>100</profile_maxLength>
<profile_tooLong>split</profile_tooLong>
<profile_dcsCapability>us-ascii,ucs2</profile_dcsCapability>
<profile_replyCapability>mcr</profile_replyCapability>
<profile_roam>yes</profile_roam>

</profile>
<tcp>

<tcp_host>btcellnet.net</tcp_host>
<tcp_port>25</tcp_port>

<tcp_resolve>true</tcp_resolve>

</tcp>
<smtp>

<smtp_localdomain>mobilesys.com</smtp_localdomain>

<smtp_pin_extraction_rule>\msubstr(\mDB(msgstatus,msgstatus_abstract_pin) \m, 1,-
1) \m@btcellnet.net</smtp_pin_extraction_rule>

</smtp>

</node>
<!-- BTCellnet CGI service -->
<node id=“btcellnet:cgi” class=“service” name=“BTCellnet CGI Server”

priority=“0”>

<profile>

<profile_carrier>pacbell</profile_carrier>
<profile_cost>2</profile_cost>
<profile_latency>200</profile_latency>
<profile_bandwidth>3</profile_bandwidth>
<profile_maxDeliveryAttempts>1</profile_maxDeliveryAttempts>
<profile_splitLimit>1000</profile_splitLimit>
<profile_maxLength>100</profile_maxLegth>
<profile_tooLong>split</profile_tooLong>

</profile>

<tcp>
<tcp_host>btcellnet.net</tcp_host>
<tcp_port>80</tcp_port>

</tcp>
<cyi>

<cgi_maxlength>120</cgi_maxlength>
<cgi_method>post</cgi_method>

<cgi_url>http://www.btcellnet.net/servlet/cmg.vasp.smlp.ShortMessageLaunchPad</-
cgi_Url>

<cgi_contentType>application/x-www-form-urlencoded</cgi_contentType>
<cgi_successStr>Message Sent!</cgi_successStr>

<cgi_query>LANGUAGE = en; \

NETWORK = smsc1; \
DELIVERY_TIME = 0; \
RECIPIENT = \mDB(msgcgi,msgcgi_recipient)\m; \
SENDER = \mDB(msgcgi,msgcgi_sender)\m; \
NOTIFICATION_FLAG = \mDB(msgcgi,msgcgi_notifyFlag)\m; \
NOTIFICATION_ADDRESS = \mDB (msgcgi, msgcgi_notifyAddr) \m; \
SHORT_MESSAGE = \mDB (msgcgi , msgcgi_msgText) \m; </cgi_query>

<cgi_notifyFlag>false</cgi_notifyFlag>

</cgi>

</node>
<!-- Vodafone OIS service -->
. . .
<!-- NexTel SNPP service -->
...

The above portion of the services section shows that BTCellNet offers two services btcellnet:smtp and btcellnet:cgi. The profile information indicates that btcellnet:smtp is a roaming service, while btcellnet:cgi is not. The two services are illustrated in FIG. 13 with btcellnet:smtp represented by S1 1316 and btcellnet:cgi represented by S2 1318. The (R) symbol for S1 1316 indicates that S1 1316 is a roaming service.

Table 2 below lists the delivery services provided by each of the four carriers, as indicated in the configuration XML table in Appendix B.

TABLE 2
Carriers and Their Respective Delivery Services

| Carrier | Services | | |
|---|---|---|---|
| pacbell 1302 | pacbell:smtp 1310 | pacbell:tap 1312 | pacbell:cgi |
| | | | 1314 |
| btcellnet 1304 | btcellnet:smtp 1316 | btcellnet:cgi 1318 | |
| nextel 1306 | nextel:smtp 1320 | nextel:snpp 1322 | |
| vodafone 1308 | vodafone:ois 1324 | | |

Table 3 below summarizes the reply capability, DCS capability, latency and cost for the services in the configuration XML table in Appendix B. The DCS (Data Coding Scheme) capability refers to the format of the data, such as ASCII, the GSM (Global Standard for Mobile Communication) alphabet, Unicode, or binary.

TABLE 3
Profile of Delivery Services

| Service | Reply Capability | DCS Capability | Latency | Cost |
|---|---|---|---|---|
| pacbell:srntp 1310 | 1-way | ASCII | 100 | 1 |
| pacbell:tap 1312 | 1-way | ASCII | 180 | 2 |
| pacbell:cgi 1314 | 1-way | ASCII | 200 | 1 |
| btcellnet:smtp 1316 | 2-way | ASCII & | 400 | 6 |
| | | Unicode | | |
| btcellnet:cgi 1318 | 1-way | ASCII | 200 | 1 |
| nextel:smtp 1320 | 1-way | ASCII | 300 | 1 |
| nextel:snpp 1322 | 1.7-way | ASCII | 150 | 5 |
| vodafone:ois 1324 | 2-way | ASCII & | 200 | 7 |
| | | Unicode | | |

The operation of an OPM system 106 with the XML configuration file in Appendix B can be illustrated with the following simple message:

<?xml version=“1.0”?
<!DOCTYPE mobilesys SYSTEM “mobilesys.dtd”>
<mobilesys>

<node id=“opm_msg_1” class=“message”>

<receiver>16507962369</receiver>
<data>

<data_message>Hello World from MX OPM: how are you?</data_message>

</data>

</node>

</mobilesys>

The OPM system 106 begins the processing of this message by determining the primary carrier from the carrier lookup table 220 using the PIN number 16507962369. Assuming that the primary carrier is determined to be pacbell, then Table 1 indicates that the message may also be delivered by btcellnet C2 1304 and vodafone C4 1308, because btcellnet C2 1304 and vodafone C4 1308 both provide roaming services for pacbell C1 1302. Therefore, any services offered by pacbell C1 1302 and any roaming services offered by btcellnet C2 1304 and vodafone C4 1308 are available for delivery of the message. The services that are available for delivery of the message are listed in Table 4 below.

TABLE 4
Available Delivery Services for Message Example

| Service | Reply Capability | Dcs Capability | Latency | Cost |
|---|---|---|---|---|
| pacbell:smtp 1310 | 1-way | ASCII | 100 | 1 |
| pacbell:tap 1312 | 1-way | ASCII | 180 | 2 |
| pacbell:cgi 1314 | 1-way | ASCII | 200 | 1 |
| btcellnet:smtp 1316 | 2-way | ASCII & | 400 | 6 |
| | | Unicode | | |
| vodafone:ois 1324 | 2-way | ASCII & | 200 | 7 |
| | | Unicode | | |

Next, the available services are ranked in accordance with criteria that may be provided by a default node in a configuration file, a customer profile table, a recipient node for a recipient specific rule, or a message delivery requirement for a message-specific rule. For example, the available services may be ranked first in ascending order of cost and then in ascending order of latency to produce the ranked list of delivery services in Table 5 below.

TABLE 5
Ranked List of Delivery Services

| Service | Reply Capability | DCS Capability | Latency | Cost |
|---|---|---|---|---|
| pacbell:smtp 1310 | 1-way | ASCII | 100 | 1 |
| pacbell:cgi 1314 | 1-way | ASCII | 200 | 1 |
| pacbell:tap 1312 | 1-way | ASCII | 180 | 2 |
| btcellnet:smtp 1316 | 2-way | ASCII & | 400 | 6 |
| | | Unicode | | |
| vodafone:ois 1324 | 2-way | ASCII & | 200 | 7 |
| | | Unicode | | |

In this example, the OPM system 106 will use the ranked list of delivery services in Table 5 and first attempt delivery using the pacbell:smtp 1310 delivery service. If delivery by the pacbell:smtp 1310 delivery service fails, the OPM system 106 will proceed down the ranked list of delivery services until delivery is successful or else all the delivery services have been tried and have failed.

The operation of the OPM system may also be illustrated with the following message:

<?xml version=“1.0”>
<!DOCTYPE mobilesys SYSTEM “mobilesys.dtd”>
<mobilesys>

<node id=“2way_msg_1” class=“message”>

<receiver carriername=“pacbell”>1650551234</receiver> <!-- a device -->
<data>

<data_from>jjw</data_from>
<data_message>Hello from jjw: How are you today?</data_message>
<data_notify>delivered,read</data_notify>
<data_mcrMsg>I'm just fine|I'm ok|I'm sick</data_mcrMsg>

</data>

</node>

</mobilesys>

In contrast to the message in the preceding example, this message requires a delivery service that is capable of sending either a 1.7-way (i.e., a message which permits a multiple choice response) or 2-way (i.e., a message which permits a full text response) message. The available services capable of sending a 1.7-way or 2-way message are restricted to btcellnet:smtp 1316 and vodafone:ois 1324. If these services were ranked in ascending order of cost, the OPM system 106 would first attempt delivery using btcellnet:smtp 1316 and if that attempt fails, then the OPM system would attempt delivery using vodafone:ois 1324.

### Implementation of the Optimized Persistent Messaging System Using the Internet

FIG. 14 illustrates an implementation of a message delivery system in accordance with an embodiment of the present invention in which messages are transferred over the Internet using two proxies. As shown in FIG. 14, a message 1102 is received by a Client MX messaging system 1402. An MX messaging system is a system for converting a computer network message into a message that can be delivered by a network device. The Client MX messaging system generates a null transport conduit and a special transport protocol for delivery of a proxy transport message to a first proxy 1404. The first proxy 1404 securely forwards the proxy transport message to a second proxy 1412 over the internet 1408 through a first firewall 1406 and a second firewall 1410. The second proxy 1412 then transmits the proxy transport message to one of an array of OPM systems 106, which generates a transport message for delivery to a receiving device 110 by the selected delivery service 108-1, 108-2 or 108-3. An array of OPM systems 106 is provided in order to allow for load balancing to facilitate the delivery of a large number of messages.

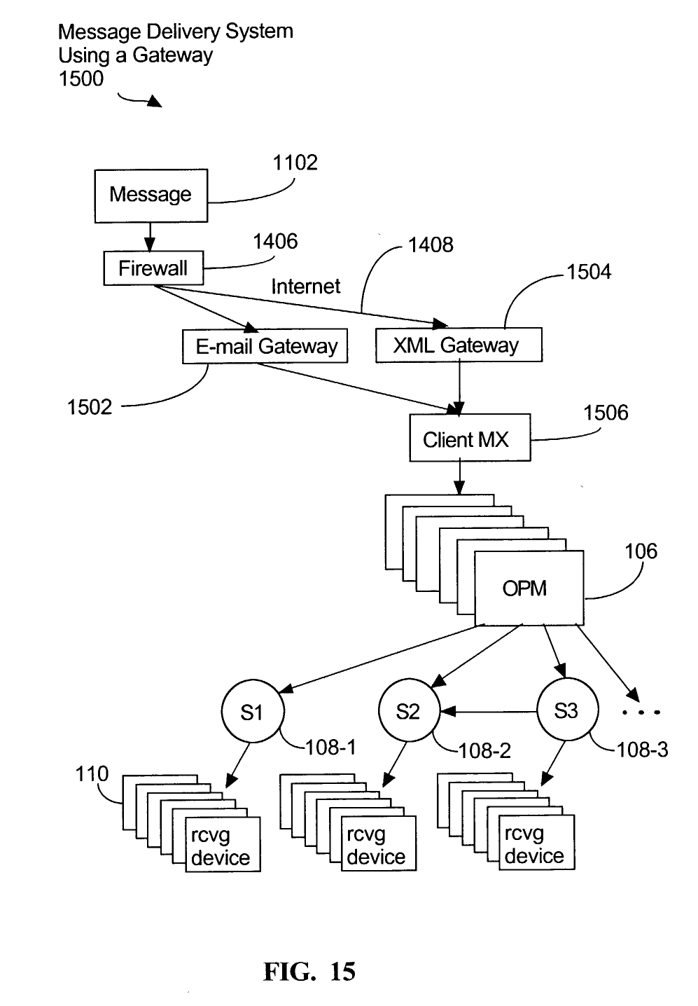

FIG. 15 illustrates a different implementation of a message delivery system in accordance with an alternate embodiment of the present invention in which messages are transferred over the internet using a secure gateway. As shown in FIG. 15, a message 1102 is sent through a firewall 1406 for transmission over the Internet 1408 to either a secure e-mail gateway 1502 or a secure XML gateway 1504, depending on whether the message is an e-mail or an XML message. The message 1102 is then delivered by either the e-mail gateway 1502 or XML gateway 1504 to a Client MX messaging system 1506. The Client MX messaging system 1506 performs customer identification verification and generates a null transport conduit and a special transport protocol for delivery of a proxy transport message to one of an array of OPM systems 106. The OPM system 106 generates a transport message for delivery to a receiving device 110 by the selected delivery service 108-1, 108-2 or 108-3.

### Alternate Embodiments

The present invention can be implemented as a computer program product that includes a computer program mechanism embedded in a computer readable storage medium. For instance, the computer program product could contain the program modules shown in FIG. 2. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

[image]

[image]

[image]

[image]

[image]

[image]

[image]

[image]

[image]

What is claimed is:

1. A messaging method, comprising,
receiving a message for delivery to a specified destination;
determining from among a predefined universe of message delivery services, a set of delivery services capable of delivering the message to the specified destination; and
repeatedly performing a sequence of message delivery steps, comprising:
(A) selecting a delivery service from the set of delivery services for which a termination condition has not been established;
(B) attempting to deliver the message to the specified destination using the selected delivery service; and
(C) when the attempting is not successful, repeating the attempting until a termination condition is achieved, the termination condition selected from the set consisting of successful delivery of the message and a predefined message delivery failure condition.

2. A messaging method, comprising,
receiving a message for delivery to a specified destination;
determining from among a predefined universe of message delivery services, a first set of delivery services capable of delivering the message to the specified destination;
generating a second, prioritized set of delivery services capable of delivering the message to the specified destination, wherein the second set of delivery services:
includes a plurality of distinct delivery services;
is a subset of the first set of delivery services; and
is ordered in accordance with a set of prioritization criteria applicable to delivery of the message;
storing the message, along with a representation of the second, prioritized set of delivery services, for utilization by a message delivery mechanism.

3. The messaging method of claim 2, further comprising
repeatedly performing a sequence of message delivery steps, comprising:
(A) selecting a highest priority delivery service from the second, prioritized set of delivery services for which a termination condition has not been established;
(B) attempting to deliver the message to the specified destination using the selected delivery service; and
(C) when the attempting is not successful, repeating the attempting until a termination condition is achieved, the termination condition selected from the set consisting of successful delivery of the message and a predefined message delivery failure condition.

4. The messaging method of claim 1, further comprising, after the selecting and before the attempting, converting the message to a format compatible with the selected delivery service.

5. The messaging method of claim 4, wherein converting the message comprises specifying a wireless message transport protocol and a wireless message transport conduit.

6. The messaging method of claim 2, wherein the set of prioritization criteria applicable to delivery of the message include message prioritization criteria specified by a customer service level agreement applicable to the message.

7. The messaging method of claim 2, wherein the set of prioritization criteria applicable to delivery of the message further include message prioritization criteria specified within the message.

8. The messaging method of claim 1, wherein the set of delivery services capable of delivering the message to the specified destination includes delivery services capable of indirectly delivering the message to the specified destination via another delivery service.

9. The messaging method of claim 1, wherein the specified destination is a wireless device, and the set of delivery services capable of delivering the message to the specified destination includes wireless message delivery services.

10. The messaging method of claim 1, including monitoring the delivery services so as to accumulate performance statistics concerning message delivery performance of the delivery services,
wherein the determining a set of delivery services includes utilizing the accumulated performance statistics to determine which delivery services among the predefined universe of message delivery services meet predefined minimum performance requirements applicable to the message.

11. The messaging method of claim 2, including monitoring the delivery services so as to accumulate performance statistics concerning message delivery performance of the delivery services,
wherein the generating a second, prioritized set of delivery services includes utilizing the accumulated performance statistics to determine which delivery services among the first set of message delivery services best meet the set of prioritization criteria applicable to delivery of the message.

12. A computer program product for use in conjunction with a computer system, the computer program product comprising a computer readable storage medium and a computer program mechanism embedded therein, the computer program mechanism comprising:
message receiving instructions for receiving a message for delivery to a specified destination and for storing the message in a message-in data structure;
filtering instructions for determining from among a predefined universe of message delivery services, a set of delivery services capable of delivering the message to the specified destination;
message delivery instructions for repeatedly performing a sequence of message delivery steps, the message delivery instructions comprising instructions for:
(A) selecting a delivery service from the first set of delivery services for which a termination condition has not been established;
(B) attempting to deliver the message to the specified destination using the selected delivery service; and
(C) repeating the attempting when the attempting is not successful until a termination condition is achieved, the termination condition selected from the set consisting of successful delivery of the message and a predefined message delivery failure condition.

13. A computer program product for use in conjunction with a computer system, the computer program product comprising a computer readable storage medium and a computer program mechanism embedded therein, the computer program mechanism comprising:
message receiving instructions for receiving a message for delivery to a specified destination and for storing the message in a message-in data structure;
filtering instructions for determining from among a predefined universe of message delivery services, a first set of delivery services capable of delivering the message to the specified destination;
prioritizing instructions for generating a second, prioritized set of delivery services capable of delivering the message to the specified destination, wherein the second set of delivery services:
includes a plurality of distinct delivery services;
is a subset of the first set of delivery services; and
is ordered in accordance with a set of prioritization criteria applicable to delivery of the message;
message queuing instructions for storing the message, along with a representation of the second, prioritized set of delivery services, for utilization by a message delivery mechanism.

14. The computer program product of claim 13, further comprising message delivery instructions for repeatedly performing a sequence of message delivery steps, the message delivery instructions comprising instructions for:
(A) selecting a highest priority delivery service from the second, prioritized set of delivery services for which a termination condition has not been established;
(B) attempting to deliver the message to the specified destination using the selected delivery service; and
(C) repeating the attempting when the attempting is not successful until a termination condition is achieved, the termination condition selected from the set consisting of successful delivery of the message and a predefined message delivery failure condition.

15. The computer program product of claim 12, wherein the message delivery instructions include message conversion instructions for converting the message to a format compatible with the selected delivery service.

16. The computer program product of claim 15, wherein the message conversion instructions includes instructions for specifying a wireless message transport protocol and a wireless message transport conduit.

17. The computer program product of claim 13, wherein the set of prioritization criteria applicable to delivery of the message include message prioritization criteria specified by a customer service level agreement applicable to the message.

18. The computer program product of claim 13, wherein the set of prioritization criteria applicable to delivery of the message further include message prioritization criteria specified within the message.

19. The computer program product of claim 12, wherein the set of delivery services capable of delivering the message to the specified destination includes delivery services capable of indirectly delivering the message to the specified destination via another delivery service.

20. The computer program product of claim 12, wherein the specified destination is a wireless device and the first set of delivery services capable of delivering the message to the specified destination includes wireless message delivery services.

21. The computer program product of claim 12, including monitoring instructions for monitoring the delivery services so as to accumulate performance statistics concerning message delivery performance of the delivery services,
wherein the filtering instructions include instructions for utilizing the accumulated performance statistics to determine which delivery services among the predefined universe of message delivery services meet predefined minimum performance requirements applicable to the message.

22. The computer program product of claim 13, including monitoring instructions for monitoring the delivery services so as to accumulate performance statistics concerning message delivery performance of the delivery services,
wherein prioritizing instructions include instructions for utilizing the accumulated performance statistics to determine which delivery services among the first set of message delivery services best meet the set of prioritization criteria applicable to delivery of the message.

23. A messaging system, comprising:
at least one processing unit for executing procedures containing executable instructions;
memory, including a message-in data structure stored within the memory;
a carrier database stored within the memory, the carrier database storing information about a predefined universe of message delivery services;
wherein a processing unit of the at least one processing unit is configured to:
receive a message for delivery to a specified destination and for storing the message in a message-in data structure;
determine from the information in the carrier database concerning the predefined universe of message delivery services, a first set of delivery services capable of delivering the message to the specified destination;
repeatedly perform a sequence of message delivery steps, the message delivery steps comprising:
(A) selecting a delivery service from the set of delivery services for which a termination condition has not been established;
(B) attempting to deliver the message to the specified destination using the selected delivery service; and
(C) repeating the attempting when the attempting is not successful until a termination condition is achieved, the termination condition selected from the set consisting of successful delivery of the message and a predefined message delivery failure condition.

24. A messaging system, comprising:
at least one processing unit for executing procedures containing executable instructions;
memory, including a message-in data structure stored within the memory;
a carrier database stored within the memory, the carrier database storing information about a predefined universe of message delivery services;
wherein a processing unit of the at least one processing unit is configured to:
receive a message for delivery to a specified destination and for storing the message in a message-in data structure;
determine from the information in the carrier database concerning the predefined universe of message delivery services, a first set of delivery services capable of delivering the message to the specified destination;
generate a second, prioritized set of delivery services capable of delivering the message to the specified destination, wherein the second set of delivery services is a subset of the first set of delivery services and is ordered in accordance with a set of prioritization criteria applicable to delivery of the message; and
store the message in the memory, along with a representation of the second, prioritized set of delivery services, for utilization by a message delivery mechanism.

25. The messaging system of claim 24, wherein the processing unit is configured to repeatedly perform a sequence of message delivery steps, the message delivery steps comprising:
(A) selecting a highest priority delivery service from the second, prioritized set of delivery services for which a termination condition has not been established;
(B) attempting to deliver the message to the specified destination using the selected delivery service; and
(C) repeating the attempting when the attempting is not successful until a termination condition is achieved, the termination condition selected from the set consisting of successful delivery of the message and a predefined message delivery failure condition.

26. The messaging system of claim 24, wherein the message delivery steps include converting the message to a format compatible with the selected delivery service.

27. The messaging system of claim 24, wherein the message delivery steps include specifying a wireless message transport protocol and a wireless message transport conduit.

28. The messaging system of claim 24, wherein the set of prioritization criteria applicable to delivery of the message include message prioritization criteria specified by a customer service level agreement applicable to the message.

29. The messaging system of claim 24, wherein the set of prioritization criteria applicable to delivery of the message further include message prioritization criteria specified within the message.

30. The messaging system of claim 24, wherein the set of delivery services capable of delivering the message to the specified destination includes delivery services capable of indirectly delivering the message to the specified destination via another delivery service.

31. The messaging system of claim 24, wherein the specified destination is a wireless device and the first set of delivery services capable of delivering the message to the specified destination includes wireless message delivery services.

32. The messaging system of claim 24, wherein the processing unit is further configured to:
monitor the delivery services so as to accumulate performance statistics concerning message delivery performance of the delivery services; and
utilize the accumulated performance statistics to determine which delivery services among the predefined universe of message delivery services meet predefined minimum performance requirements applicable to the message.

33. The messaging system of claim 24, wherein the processing unit is further configured to:
monitor the delivery services so as to accumulate performance statistics concerning message delivery performance of the delivery services; and
utilize the accumulated performance statistics to determine which delivery services among the first set of message delivery services best meet the set of prioritization criteria applicable to delivery of the message.
